(19) United States
(12) Patent Application Publication
(10) Pub. No.: US 2006/0289122 A1
(43) Pub. Date: Dec. 28, 2006

(54) Multi-stage window covering

(76) Inventor: Shih-Ming Lin, Jiayi (TW)

Correspondence Address: NIKOLAI & MERSEREAU, P.A., 900 SECOND AVENUE SOUTH, SUITE 820, MINNEAPOLIS, MN, 55402, US

(21) Appl. No.: 11/168,669

(22) Filed: Jun. 28, 2005

(51) Int. Cl. E06B 3/48

(52) U.S. Cl. 160/115

(57) ABSTRACT

A multi-stage window covering includes a headrail, a plurality of juxtaposed covering units mounted on the headrail, and a plurality of winding mechanisms mounted in the headrail and each connected to a respective one of the covering units to control movement of each of the covering units independently. Thus, each of the covering units is operated independently by the respective winding mechanism, so that the covering zones formed by the covering units have different optical permeability to allow passage of the solar rays so as to change the outer appearance of the window covering, thereby enhancing the aesthetic quality of the window covering.

### BACKGROUND OF THE INVENTION

1. Field of the Invention

The present invention relates to a window covering, such as a Venetian blind, and more particularly to a multi-stage window covering.

2. Description of the Related Art

A conventional window covering, such as a Venetian blind, in accordance with the prior art comprises a headrail, a plurality of slats mounted on and extended from the headrail, and a lift cord extended through the slats and secured to a lowermost one of the slats to move the slats. Thus, the slats are lifted and folded by the lift cord to allow passage of the solar rays and are lowered and expanded to provide a shade effect. However, when the slats are fully expanded, the solar rays cannot penetrate the slats so that the indoor light is too weak, and when the slats are fully folded, the solar rays directly enters the indoor so that the indoor light is too intensive.

### SUMMARY OF THE INVENTION

In accordance with the present invention, there is provided a window covering, comprising a headrail, a plurality of juxtaposed covering units mounted on the headrail, and a plurality of winding mechanisms mounted in the headrail and each connected to a respective one of the covering units to control movement of each of the covering units independently.

The primary objective of the present invention is to provide a multi-stage window covering having adjustable optical permeability.

Another objective of the present invention is to provide a window covering, wherein each of the covering units is operated independently by the respective winding mechanism, so that the covering zones formed by the covering units have different optical permeability to allow passage of the solar rays so as to change the outer appearance of the window covering, thereby enhancing the aesthetic quality of the window covering.

A further objective of the present invention is to provide a window covering, wherein the optical permeability of each of the covering zones is adjusted easily so as to control the lightness of the solar rays entering the indoor, thereby facilitating a user adjusting the optical permeability of the window covering according to the practical requirement.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a window covering in accordance with the preferred embodiment of the present invention;

FIG. 2 is a perspective expanded view of the window covering as shown in FIG. 1;

FIG. 3 is a perspective expanded view of the window covering as shown in FIG. 1;

FIG. 4 is a perspective view of a window covering in accordance with another preferred embodiment of the present invention;

FIG. 5 is a perspective view of a window covering in accordance with another preferred embodiment of the present invention;

FIG. 6 is a perspective view of a window covering in accordance with another preferred embodiment of the present invention;

FIG. 7 is a perspective view of a window covering in accordance with another preferred embodiment of the present invention; and

FIG. 8 is a perspective view of a window covering in accordance with another preferred embodiment of the present invention.

### DETAILED DESCRIPTION OF THE INVENTION

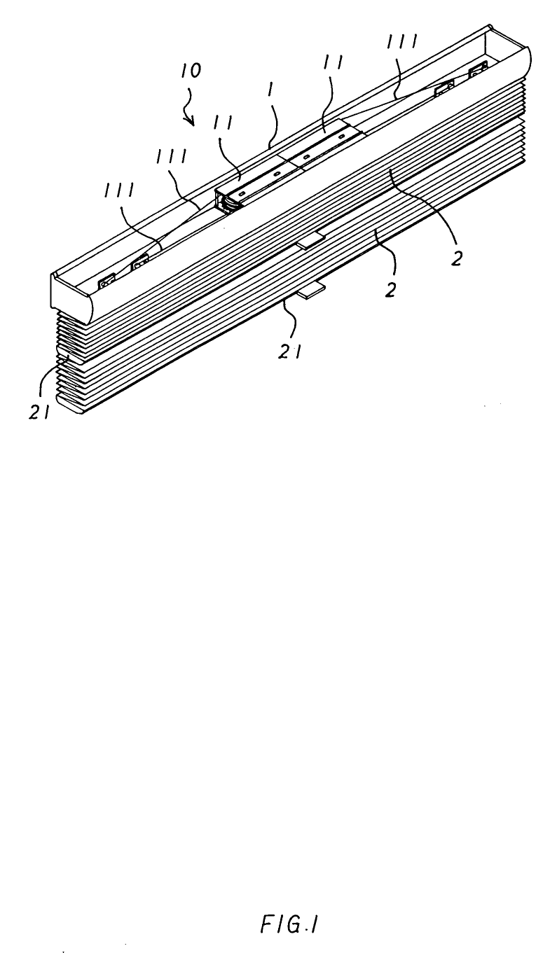

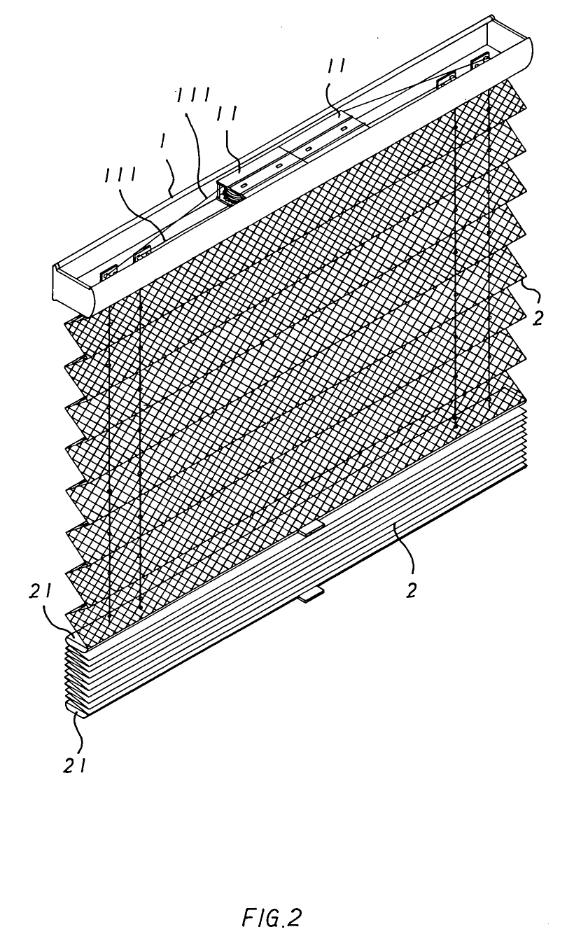

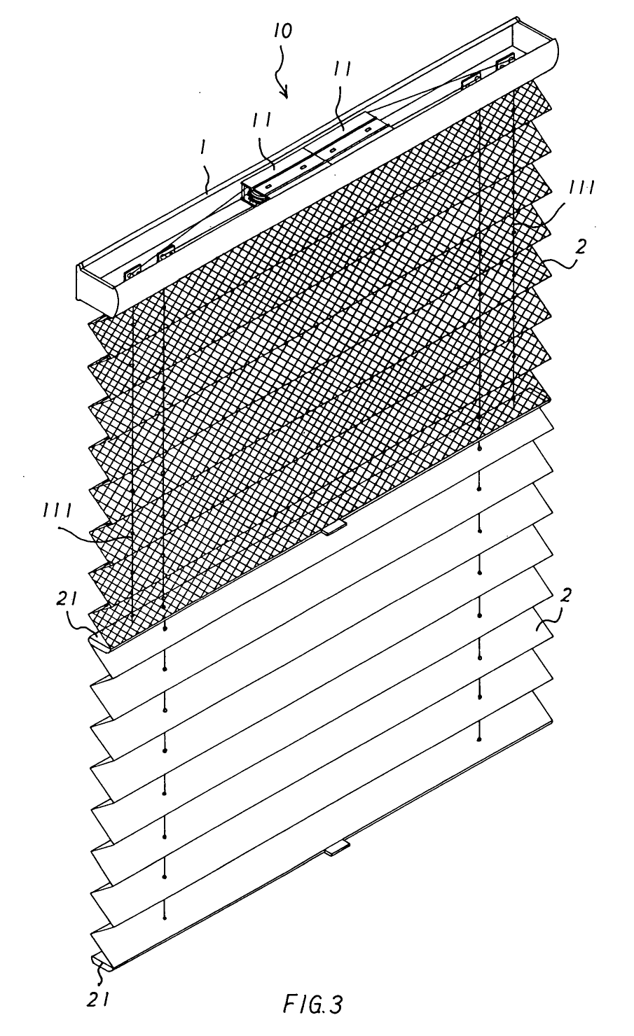

Referring to the drawings and initially to FIGS. 1-3, a multi-stage window covering 10 in accordance with the preferred embodiment of the present invention comprises a headrail 1, a plurality of juxtaposed covering units 2 mounted on the headrail 1, and a plurality of winding mechanisms 11 mounted in the headrail 1 and each connected to a respective one of the covering units 2 to control movement of each of the covering units 2 independently.

The covering units 2 are serially connected with each other to form multiple independent covering zones that are operated by each of the winding mechanisms 11 independently. Each of the winding mechanisms 11 includes at leas one hanging cord 111 connected to a respective one of the covering units 2 to control movement of the respective covering unit 2 independently. Thus, each of the covering units 2 is operated (opened or closed) independently by the respective winding mechanism 11, so that the covering zones formed by the covering units 2 have different optical permeability to allow passage of the solar rays so as to change the outer appearance of the window covering 10, thereby enhancing the aesthetic quality of the window covering 10. In addition, the optical permeability of each of the covering zones is adjusted easily so as to control the lightness of the solar rays entering the indoor, thereby facilitating a user adjusting the optical permeability of the window covering 10 according to the practical requirement.

The window covering further comprises a plurality of bottom rails 21 each mounted on a bottom of a respective one of the covering units 2 and each connected to and driven by the hanging cord 111 of a respective one of the winding mechanisms 11. Each of the bottom rails 21 on the respective covering unit 2 is connected to a lower adjacent covering unit 2 so that the covering units 2 are connected by the bottom rails 21. In addition, the hanging cord 111 connected to each of the covering units 2 is extended through an upper adjacent covering unit 2 so that the covering units 2 are arranged serially.

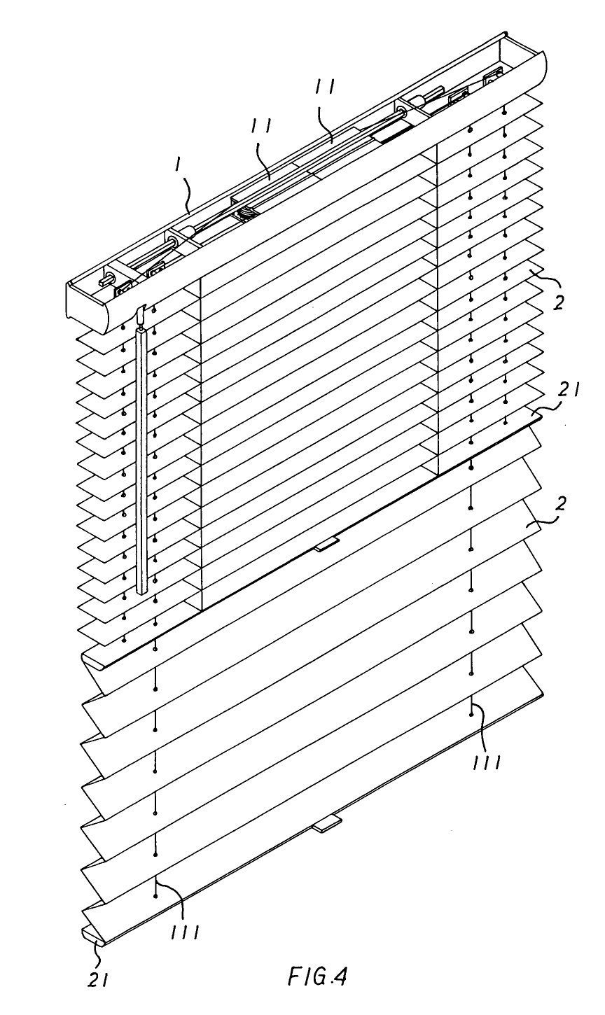

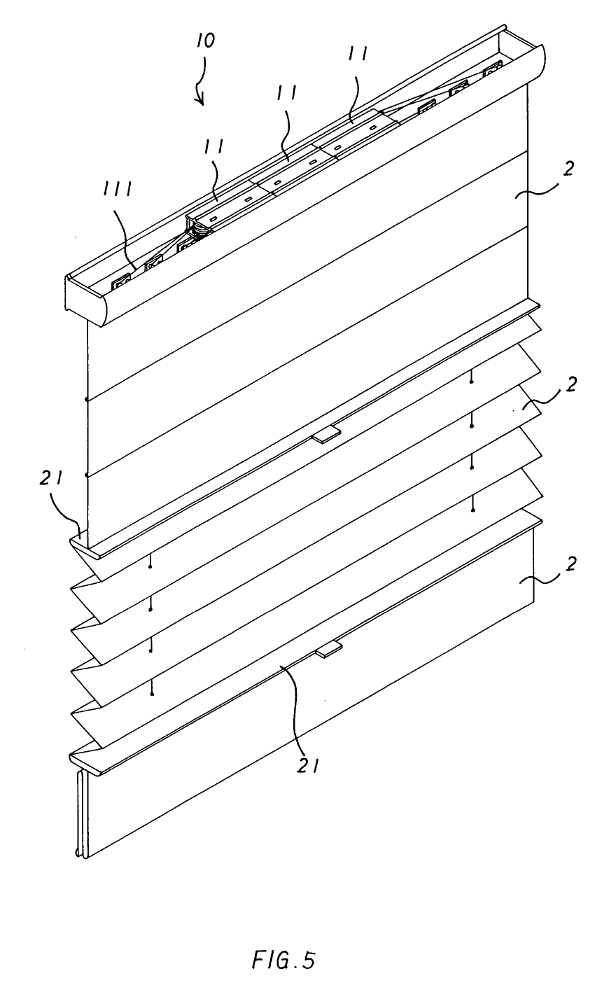

As shown in FIGS. 4 and 5, the covering units 2 have different colors, patterns and shapes, thereby enhancing the aesthetic quality of the window covering.

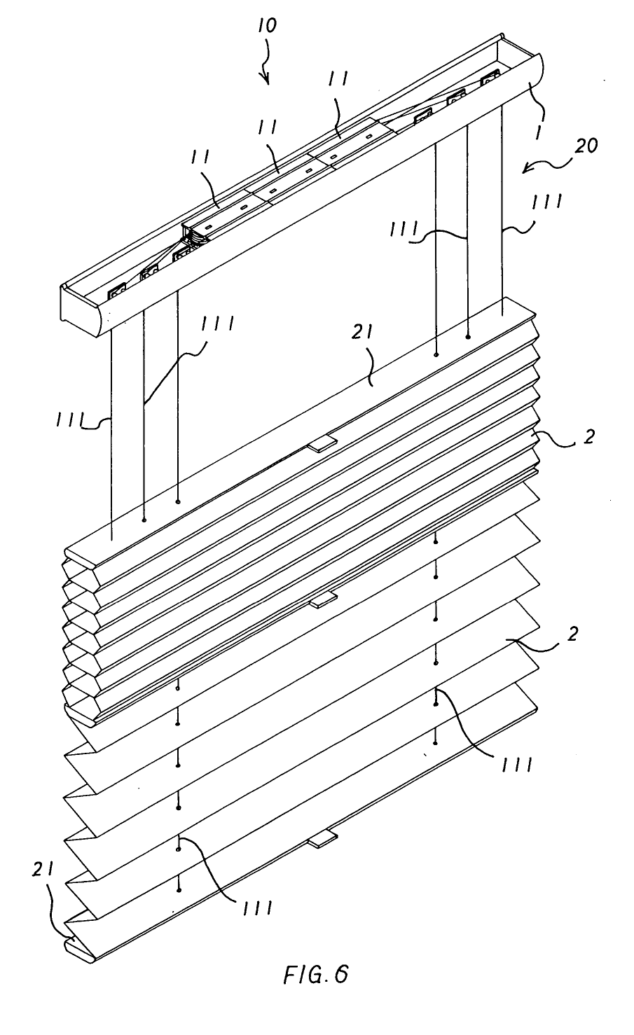

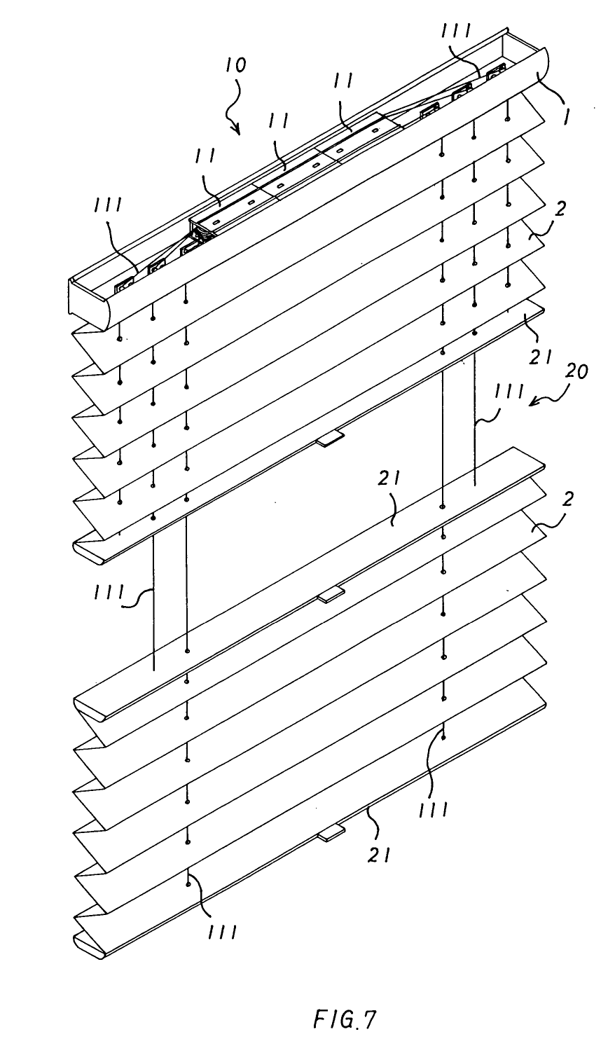

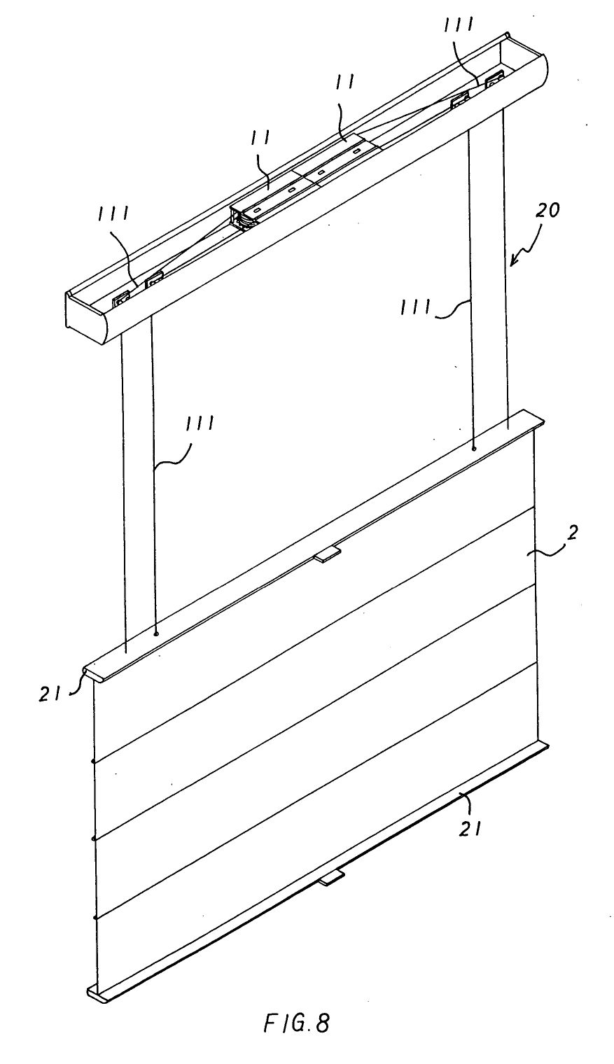

As shown in FIGS. 6-8, at least one opening 20 is formed between the covering units 2 or between the covering units 2 and the headrail 1, so that at least one covering zone formed by the respective covering unit 2 only has the bottom rail 21, thereby locally changing the optical permeability of the window covering.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A window covering, comprising:
a headrail;
a plurality of juxtaposed covering units mounted on the headrail;
a plurality of winding mechanisms mounted in the headrail and each connected to a respective one of the covering units to control movement of each of the covering units independently.

2. The window covering in accordance with claim 1, wherein the covering units are serially connected with each other to form multiple independent covering zones.

3. The window covering in accordance with claim 2, wherein the covering zones are operated by each of the winding mechanisms independently.

4. The window covering in accordance with claim 1, wherein each of the covering units is operated independently by the respective winding mechanism, so that the covering zones formed by the covering units have different optical permeability to allow passage of solar rays.

5. The window covering in accordance with claim 1, wherein each of the winding mechanisms includes at leas one hanging cord connected to a respective one of the covering units to control movement of the respective covering unit independently.

6. The window covering in accordance with claim 5, further comprising a plurality of bottom rails each mounted on a bottom of a respective one of the covering units and each connected to and driven by the hanging cord of a respective one of the winding mechanisms.

7. The window covering in accordance with claim 6, wherein each of the bottom rails on the respective covering unit is connected to a lower adjacent covering unit so that the covering units are connected by the bottom rails.

8. The window covering in accordance with claim 5, wherein the hanging cord connected to each of the covering units is extended through an upper adjacent covering unit.

9. The window covering in accordance with claim 1, wherein the covering units have different colors.

10. The window covering in accordance with claim 1, wherein the covering units have different patterns.

11. The window covering in accordance with claim 1, wherein the covering units have different shapes.

12. The window covering in accordance with claim 6, wherein at least one opening is formed between the covering units, so that at least one covering zone formed by the respective covering unit only has the bottom rail.

13. The window covering in accordance with claim 6, wherein at least one opening is formed between the covering units and the headrail, so that at least one covering zone formed by the respective covering unit only has the bottom rail.
